(19) United States
(12) Patent Application Publication
(10) Pub. No.: US 2014/0002377 A1
(43) Pub. Date: Jan. 2, 2014

(54) MANIPULATING CONTENT ON A CANVAS WITH TOUCH GESTURES

(71) Applicants: Andrew Brauninger, Seattle, WA (US); Olga Veselova, Redmond, WA (US); Ned Friend, Seattle, WA (US)

(72) Inventors: Andrew Brauninger, Seattle, WA (US); Olga Veselova, Redmond, WA (US); Ned Friend, Seattle, WA (US)

(73) Assignee: MICROSOFT CORPORATION, Redmond, WA (US)

(21) Appl. No.: 13/540,594

(22) Filed: Jul. 2, 2012

(51) Int. Cl. G06F 3/041

(52) U.S. Cl. 345/173

(57) ABSTRACT

A touch gesture is received on a display screen, relative to displayed content. In response to the touch gesture, a manipulation handle, that is separate from, but related to, the displayed content, is displayed. Another touch gesture is received for moving the manipulation handle, and the related content is manipulated based on the second touch gesture that moves the manipulation handle.

### BACKGROUND

There are a wide variety of different types of computing devices that are currently available. Such devices can include desktop computers, laptop computers, tablet computers and other mobile devices such as smart phones, cell phones, multimedia players, personal digital assistants, etc. These different types of computing devices have different types of user input modes. For instance, some devices take user inputs through a point and click device (such as a mouse), or a hardware keyboard or keypad. Other devices have touch sensitive screens and receive user inputs through touch gestures either from a user's finger, from a stylus, or from other devices. Still other computers have microphones and receive voice inputs.

Of course, these different types of devices often have different size display devices. For instance, a desktop computer often has a large display device. A tablet computer has an intermediate size display device, while a smart phone or cell phone, or even some multimedia players, have relatively small display devices. All of these differences can make it difficult to manipulate content that is being displayed. For example, on a small screen device that uses touch gestures, it can be difficult to manipulate content (such as move text or an image) that is being displayed on the display device.

As one specific example, people often store list data in a document format. For example, some current note taking applications are used to keep to-do lists, shopping lists, packing lists, etc. When interacting with list items, users often wish to reorder the items in the list. A user may wish to move an important to-do list item to the top of the list. Other common tasks that are often performed on content (such as items within a list) are indenting or outdenting, which is a useful way to organize a long list of items.

Some current applications have relatively good affordances to support these operations for manipulating content when using a mouse or keyboard. However, performing these operations for manipulating content is still relatively problematic using touch gestures. Some applications present list data in a structured format that uses a list view control. It those applications, every item in the list is a discrete item that can be manipulated with touch. However, a less structured format, such as a word processing document canvas, does not provide these types of controls. Therefore, this exacerbates the problem of manipulating displayed content using touch gestures.

The discussion above is merely provided for general background information and is not intended to be used as an aid in determining the scope of the claimed subject matter.

### SUMMARY

A touch gesture is received on a display screen, relative to displayed content. In response to the touch gesture, a manipulation handle, that is separate from, but related to, the displayed content, is displayed. Another touch gesture is received for moving the manipulation handle, and the related content is manipulated based on the second touch gesture that moves the manipulation handle.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative computing system.

FIG. 2 is a flow diagram illustrating one embodiment of the operation of the system shown in FIG. 1.

FIGS. 2A-2K are illustrative user interface displays showing various embodiments of the operation of the system shown in FIG. 1.

FIG. 3 shows a block diagram of various architectures in which the system can be employed.

FIGS. 4-7 illustrate embodiments of mobile devices.

FIG. 8 is a block diagram of one illustrative computing environment.

### DETAILED DESCRIPTION

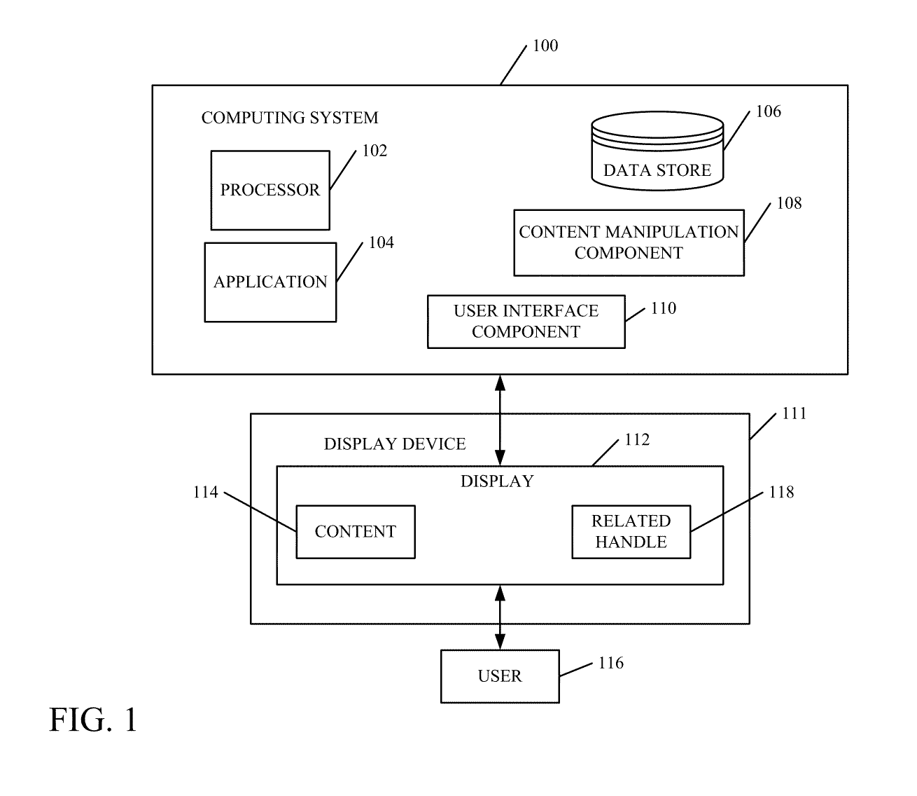

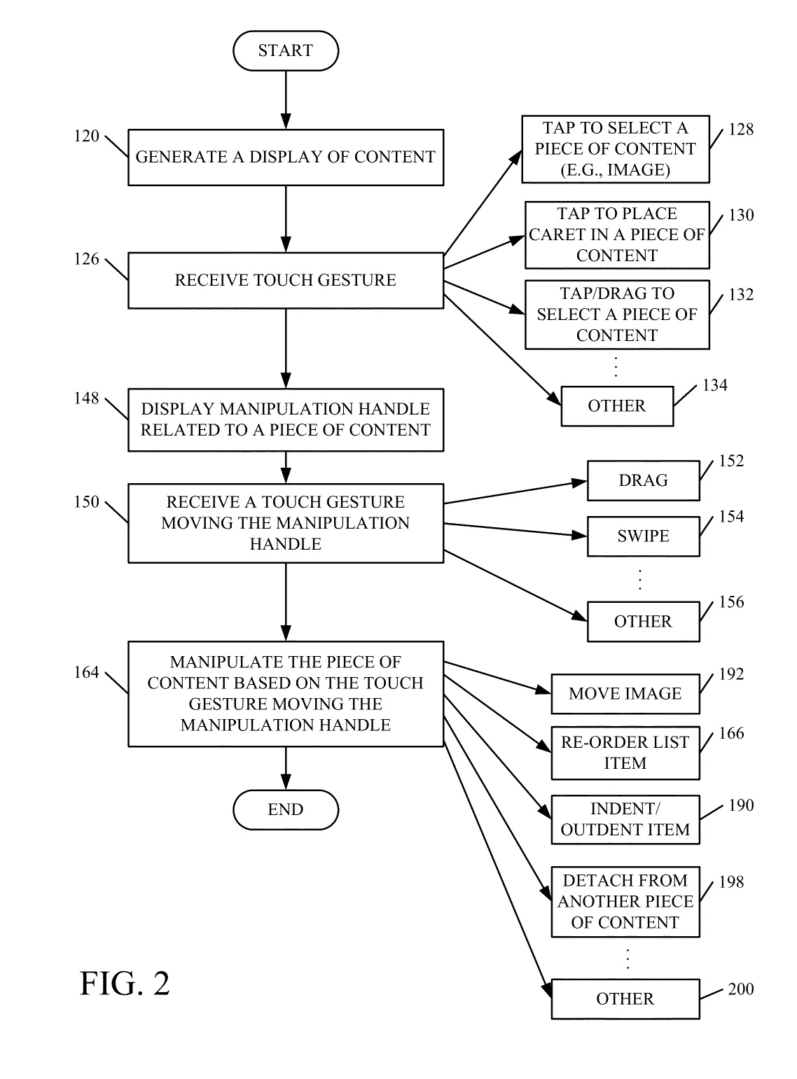

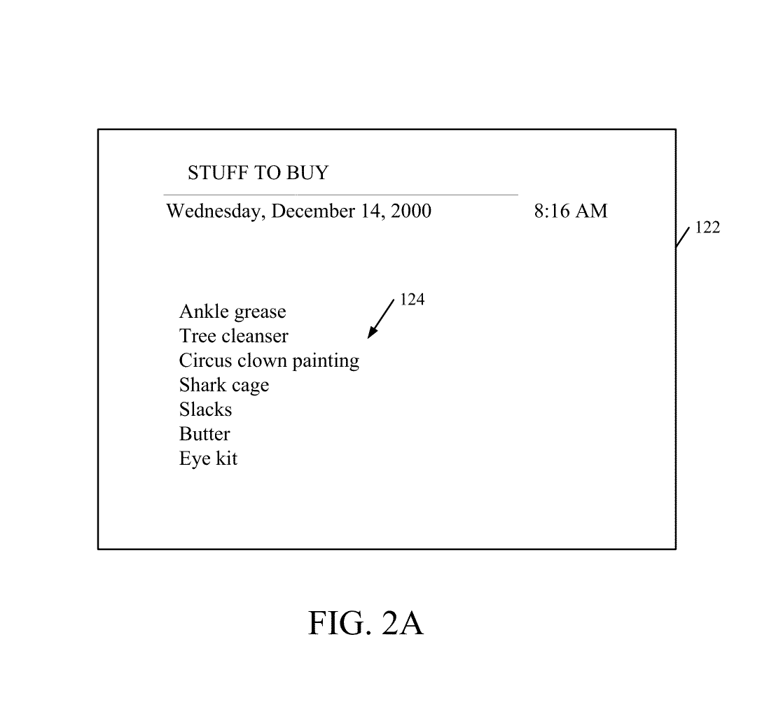

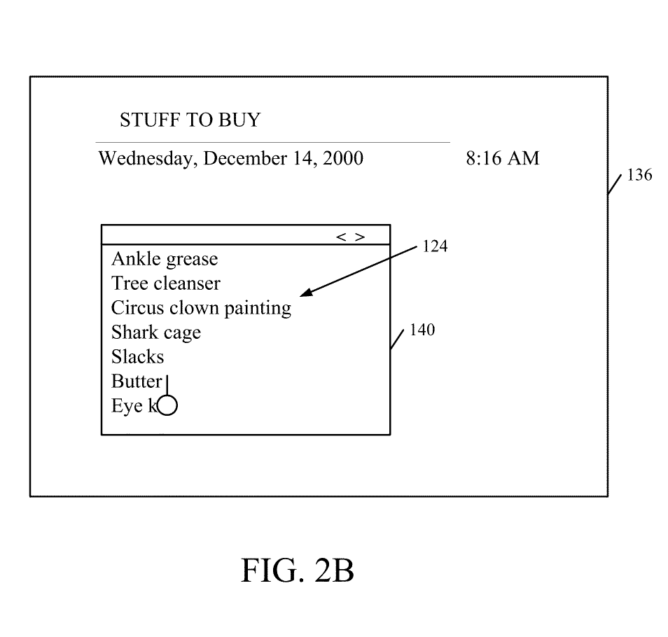

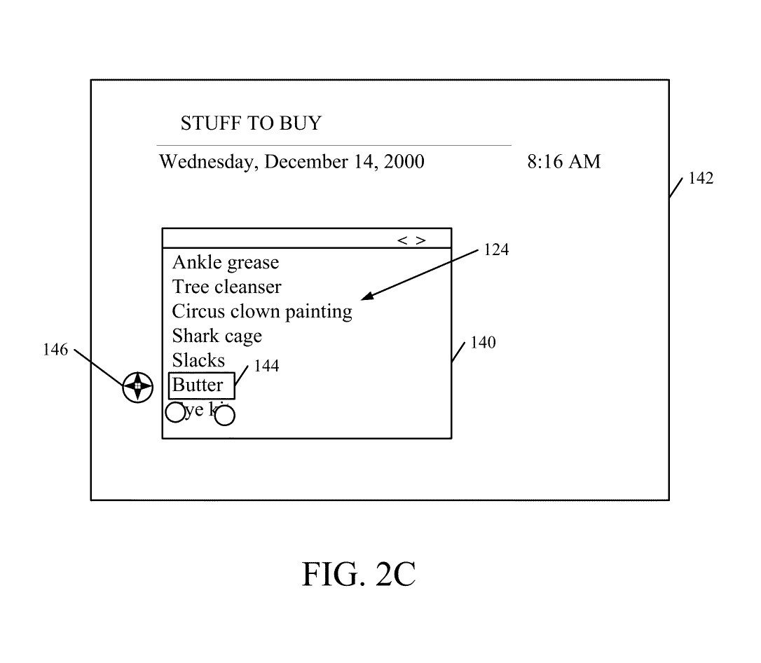

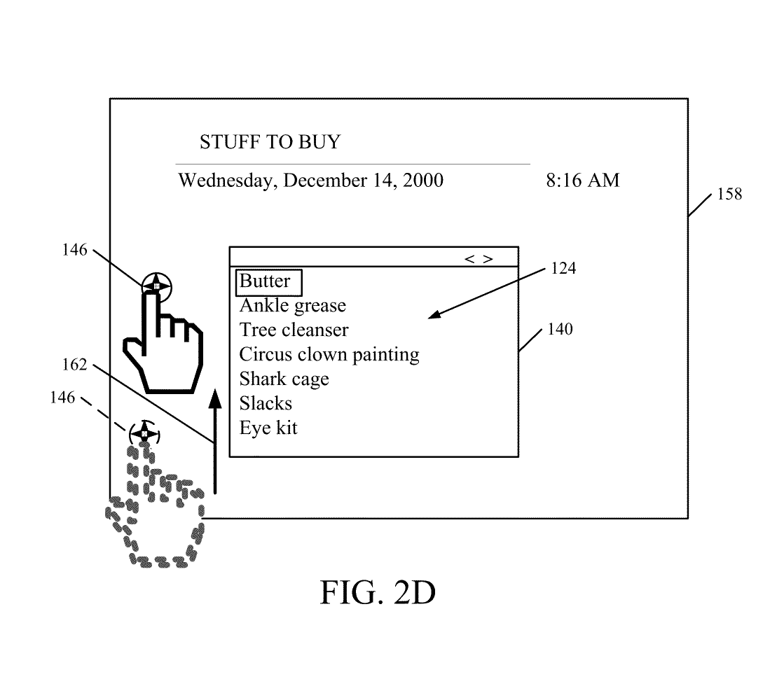

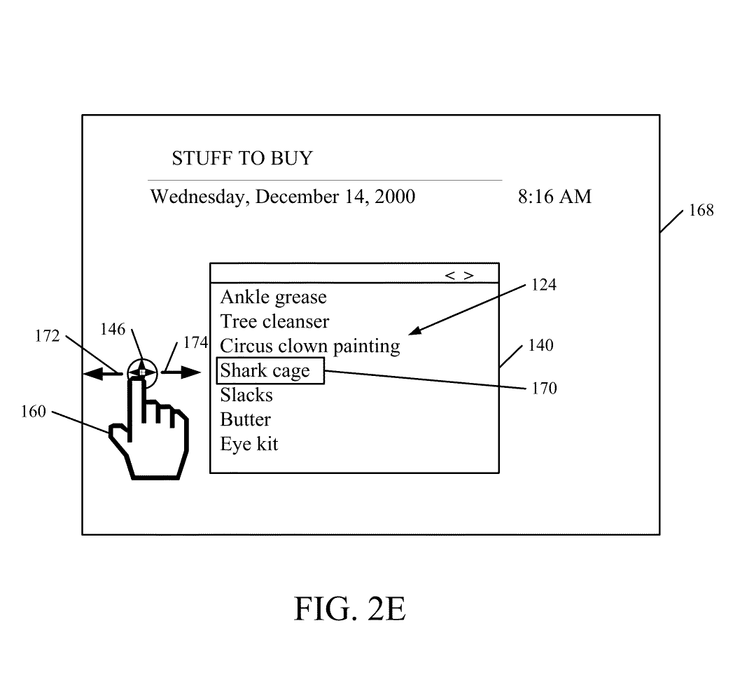

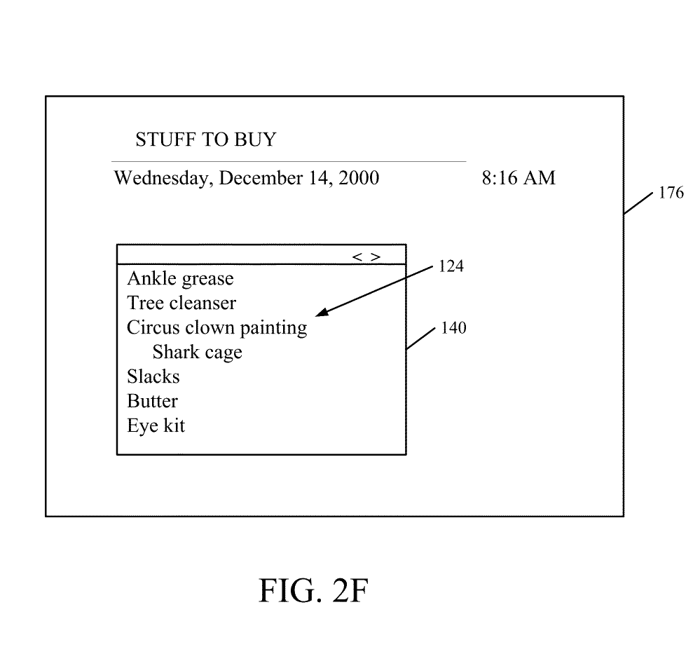

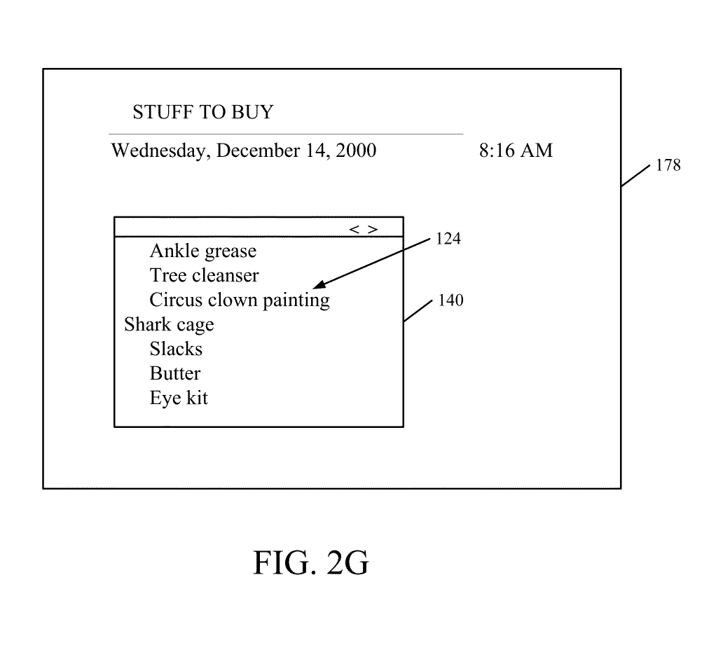

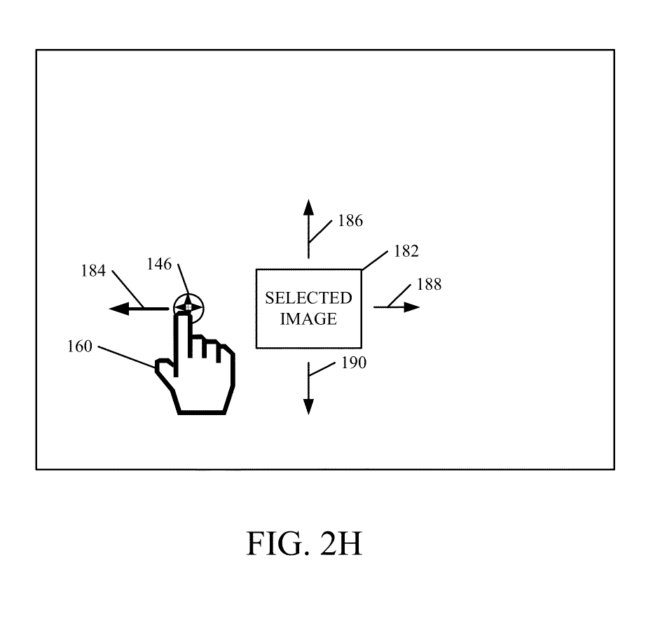

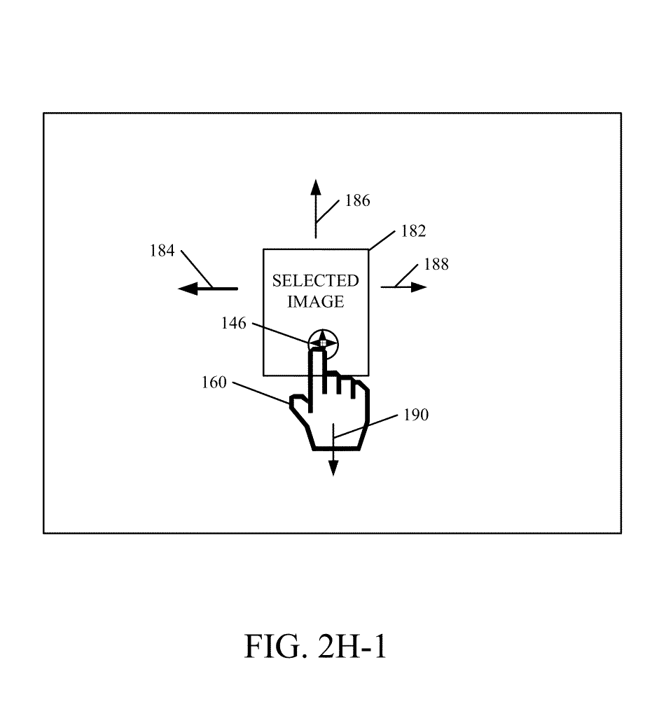

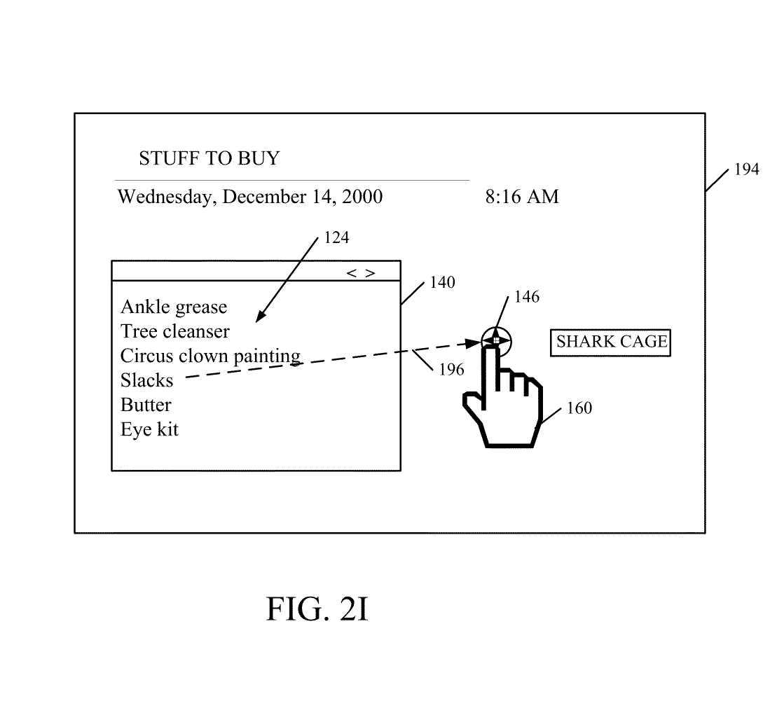

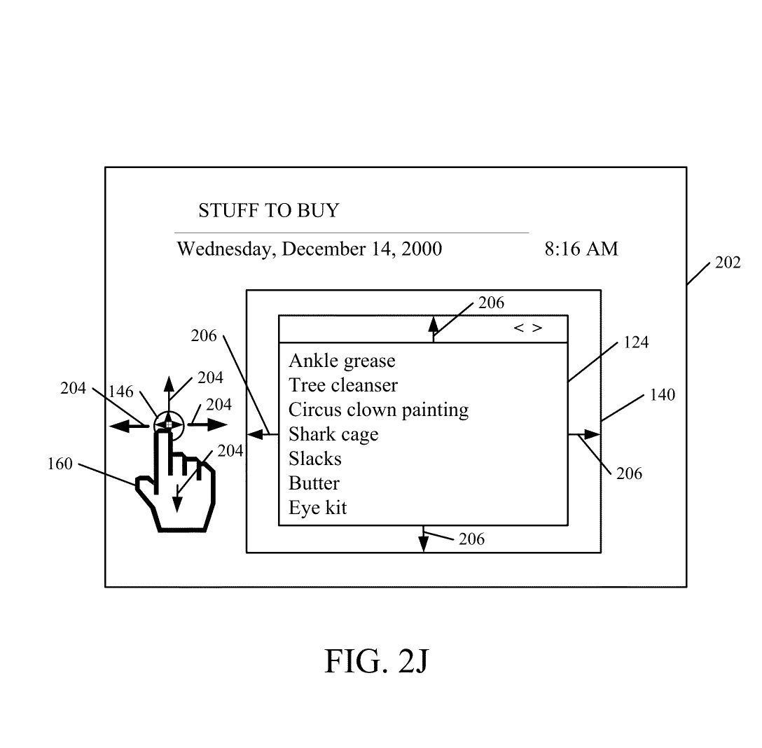

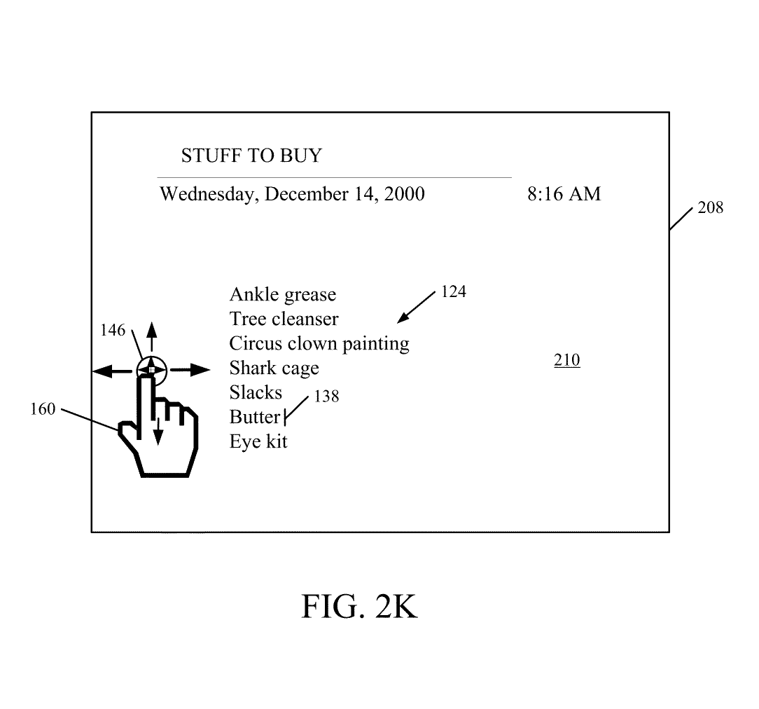

FIG. 1 shows a block diagram of one illustrative computing system 100. System 100 illustratively includes processor 102, one or more applications 104, data store 106, content manipulation component 108, and user interface component 110. User interface component 110 illustratively generates one or more user interface displays 112 that display content 114 on a display device 111. Display 112 also illustratively has user input mechanisms that receive user inputs from a user 116 that are used to manipulate content 114 and interact with application 104 or other items in computing system 100. Display 112 is also shown in FIG. 1 with related handle 118, that is related to content 114. This is described in greater detail below with respect to FIG. 2.

Display device 111 is illustratively a display device that system 100 uses to generate user interface displays 112. In the embodiment discussed herein, display device 111 is illustratively a touch sensitive display device that receives touch gestures from user 116 in order to manipulate content 114 on user interface displays 112. The touch gestures can be from a user's finger, from a stylus, or from another device or body part.

In one embodiment, processor 102 is illustratively a computer processor with associated memory and timing circuitry (not shown). Processor 102 is illustratively a functional part of system 100 and is activated by, and interacts with, the other items in computing system 100.

Application 104 can be any of a wide variety of different applications that uses user interface component 110 to generate various user interface displays 112. In one embodiment, application 104 is a note taking application that can be accessed in a collaborative environment. However, application 104 can also be a word processing application or any other type of application that generates displays of content.

Data store 106 illustratively stores data that is used by application 104. Data store 106, of course, can be a plurality of different data stores, or a single data store.

Content manipulation component 108 illustratively manipulates content 114 on user interface displays 112 based on inputs from user 116. In one embodiment, content manipulation component 108 is part of application 104. Of course, it can be a separate component as well. Both of these architectures are contemplated.

FIG. 2 is a flow diagram illustrating one embodiment of the operation of system 100 shown in FIG. 1, and specifically the operation of content manipulation component 108 in manipulating content 114 on display 112. System 100 (and illustratively application 104 using user interface component 110) first generates a display of content 114 on a user interface display 112. Display device 111. Generating a display of content is indicated by block 120 in FIG. 2.

FIG. 2A shows one illustrative user interface display 122 that displays content. In the embodiment shown in FIG. 2A, user interface component 110 has generated display 122 where content 114 comprises a list 124 of text items.

System 100 then receives a touch gesture from user 116 relative to list 124. This is indicated by block 126 in FIG. 2. The touch gesture can be one of a plurality of different touch gestures and content manipulation component 108 can perform different functions based on the specific touch gesture. For instance, in one embodiment, the touch gesture is a tap (or touch) on the display device 111 to select a piece of content, such as an image. This is indicated by block 128 in FIG. 2. In another embodiment, the touch gesture is a tap (or touch) to place a caret in a piece of displayed content 114. This is indicated by block 130. In another embodiment, the touch gesture is a tap and drag to select a piece of content 114. This is indicated by block 132. Of course, the touch gesture can be other touch gestures as well, and this is indicated by block 134.

FIG. 2B shows one embodiment of a user interface display 136 that is generated when the user taps list 124 to place a caret, or cursor, 138 within list 124. In certain embodiments, content manipulation component 108 will, in response to placing cursor 138 in list 124, identify list 124 as a structural list, and place a display border 140 around it, thereby grouping the items in list 124 together as a single item. In other embodiments, of course, border 140 is not placed around list 124.

The present discussion will proceed with respect to the embodiment where the user taps the user interface display on list 124 to place cursor 138 in the list and then drags his or her finger (or stylus) to select a list item. This corresponds to block 132 in the flow diagram of FIG. 2. In that embodiment, user interface component 110 generates user interface display 142 shown in FIG. 2C. It can be seen that the user has dragged his or her finger (or stylus) to the left over the list item “Butter” thus selecting the list item “Butter”. This is indicated by the box 144 around the list item “Butter”.

In response, content manipulation component 108 displays a manipulation handle 146 closely proximate the selected list item Butter. Manipulation handle 146 corresponds to related handle 118 in FIG. 1. Handle 146 is related to the highlighted list item in list 124. Of course, it will be appreciated that content manipulation component 108 could just as easily have displayed manipulation handle 146 as soon as the user tapped the user interface display to place cursor 138 on list 124. However, the present description will proceed with respect to manipulation handle 146 only being placed on the user interface display when the user has selected some content that is being displayed. Therefore, FIG. 2C shows that content manipulation component 108 has placed manipulation handle 146 closely proximate the selected list item in list 124. Displaying the manipulation handle 146 related to the selected piece of content is indicated by block 148 in FIG. 2.

In another embodiment, content manipulation component 108 then receives another touch gesture that moves manipulation handle 146 on the user interface display. This is indicated by block 150 in FIG. 2. This touch gesture moving the manipulation handle 146 can be a dragging touch gesture 152, a swiping touch gesture 154 or another type of touch gesture 156. In any case, FIG. 2D shows one exemplary user interface display 158 that illustrates the touch gesture that moves manipulation handle 146 on the user interface display. It can be seen that the user has placed his or her finger 160 on the manipulation handle 146 and moved it in an upward direction on user interface display 158 from the position shown in phantom, in the direction of arrow 162, to the position shown in solid lines. As the user moves manipulation handle 146, the related content (i.e., the selected list item “Butter”) moves along with the manipulation handle 146. In the embodiment shown in FIG. 2D, the user has effectively moved the list item “Butter” to the top of list 124. It can thus be seen that content manipulation component 108 manipulates the piece of content based on the touch gesture that moves the manipulation handle 146. This is indicated by block 164 in FIG. 2.

In the embodiment shown in FIG. 2D, content manipulation component 108 reorders the list items in list 124 based on that touch gestures. This is indicated by block 166 in FIG. 2. For instance, in one embodiment, content manipulation component 108 not only moves the list item “Butter” corresponding to manipulation handle 146 to the top of the list, but it moves the remaining elements in list 124 downward to make room for “Butter” at the top of list 124. Of course, if the user had simply moved the list item “Butter” up three places (for instance), then content manipulation component 108 would have moved the other items in the list downward to make room for “Butter” at the that spot in the list.

Content manipulation component 108 can manipulate the piece of content related to the manipulation handle 146 in other ways as well, based on other touch gestures. For instance, FIG. 2E shows an embodiment of a user interface display 168 that shows that the user has selected the list item “Shark cage” in list 124, and this is indicated by the box 170 around the list item “Shark cage”. User interface display 168 also shows that content manipulation component 108 has generated the display of manipulation handle 146 related to the selected piece of content (i.e., related to Shark cage). If the user uses his or her finger 160 to move manipulation handle 146 to the left as indicated by arrow 172, or to the right, as indicated by arrow 174, then content manipulation component 108 illustratively outdents, or indents, the related list item “Shark cage”.

FIG. 2F shows one embodiment of a user interface display 176 which is similar to that shown in FIG. 2E, and similar items are similarly numbered. However, in FIG. 2F, it can be seen that the user has moved his or her finger 160 to the right as indicated by arrow 174 in FIG. 2E. This causes content manipulation component 108 to indent the related content (i.e., the selected list item “Shark cage”).

FIG. 2G shows an embodiment of another user interface display 178 where the user 116 has moved his or her finger to the left as indicated by arrow 172 in FIG. 2E. This causes content manipulation component 108 to outdent the related content (i.e., the selected list item “Shark cage”). Indenting and outdenting the list item based on the touch gesture is indicated by block 180 in the flow diagram of FIG. 2.

FIGS. 2H and 2H-1 are other embodiments in which the displayed content 114 comprises an image 182. When the user selects image 182, content manipulation component 108 illustratively displays the related manipulation handle 146 now related to the selected image 182. FIG. 2H shows handle 146 displaced from image 182, while FIG. 2H-1 shows handle 146 on top of image 182. Therefore, as the user uses his or her finger 160 to move manipulation handle 146 in various directions, such as the directions 184, 186, 188 and 190, content manipulation component 108 illustratively moves selected image 182 in the same direction around the display. Moving a selected image is indicated by block 192 in FIG. 2.

In another embodiment, if the user 116 uses his or her finger 160 to move manipulation handle 146 far enough away from list 124, content manipulation component 108 detaches the selected list item (related to manipulation handle 146) from the remainder of list 124. FIG. 2I shows one illustrative user interface display 194 in which the user has selected the list item “Shark cage” and content manipulation component 108 has displayed manipulation handle 146. The user has moved manipulation handle 146 (using his or her finger 160) to the right in the direction indicated by arrow 196. When the user moves manipulation handle 146 past the boundary of boarder 140, content manipulation component 108 reconfigures display 194 so that the selected list item “Shark cage” is no longer considered part of list 124, but is considered its own, separate piece of displayed content. Detaching the piece of content that is related to manipulation handle 146 from another piece of content is indicated by block 198 in FIG. 2.

Of course, content manipulation component 108 can perform other manipulations on the piece of content based on the touch gesture that moves the manipulation handle 146 as well. This is indicated by block 200 in FIG. 2.

FIG. 2J illustrates one other such manipulation. In the embodiment shown in FIG. 2J, a user interface display 202 illustrates that the user uses his or her finger 160 to select the entire list 124. In one embodiment, the user does this by tapping on the displayed manipulation handle 146. In other words, if the user has provided a touch gesture that causes content manipulation component 108 to display manipulation handle 146 on the user interface display, and the user then taps on manipulation handle 146, this, in one embodiment, causes content manipulation component 108 to select the entire piece of content of which the selected item is a part. For instance, if the user has selected the “Shark cage” list item, this will cause content manipulation component 108 to display manipulation handle 146 proximate the list item “Shark cage”. If the user then taps on manipulation handle 146, this causes content manipulation component 108 to select the entire list 124 of which the selected list item “Shark cage” is a part. In any case, manipulation handle 146 is then related to the entire selected list 124. If the user uses his or her finger 160 to move manipulation handle 146 in any direction, this causes content manipulation component 108 to move the entire list 124 in that direction as well. This is indicated by arrows 204 and 206.

FIG. 2K illustrates yet another user interface display 208. User interface display 208 shows an embodiment in which list 124 is not treated as a single display element. This is indicated by the fact that border 140 is not displayed around list 124. User interface display 208 also shows an embodiment in which content manipulation component 108 displays manipulation handle 146 even where the user has not selected any content. Instead, the user has simply placed cursor 138 within the canvas 210 of display 208. In this embodiment, moving manipulation handle 146 causes content manipulation component 108 to either move the content adjacent cursor 138 (e.g., the word “Butter”), or simply to move the cursor within the canvas 210 of display 208. Of course, other embodiments are contemplated as well.

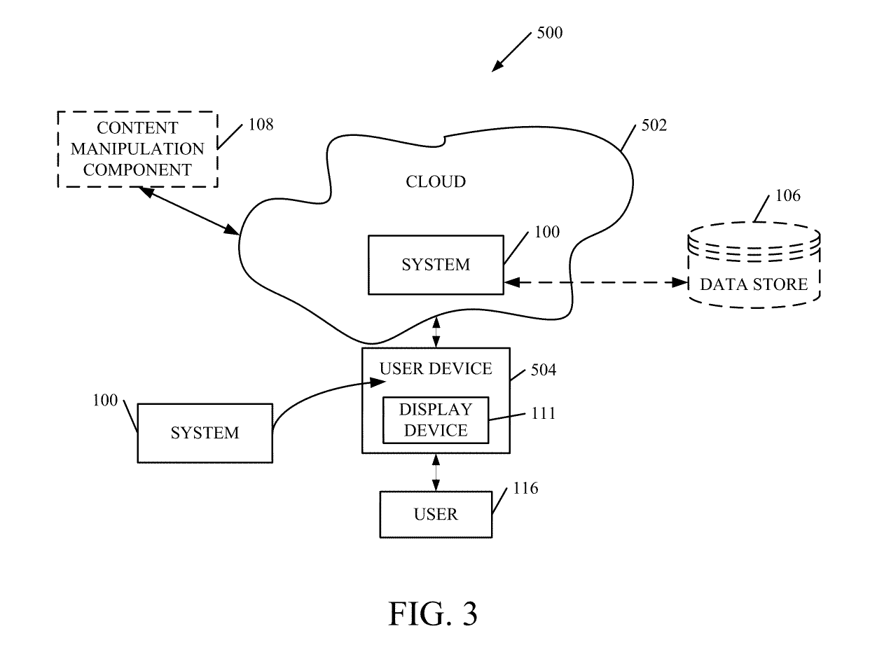

FIG. 3 is a block diagram of system 100, shown in various architectures, including cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

The embodiment shown in FIG. 3, specifically shows that system 100 is located in cloud 502 (which can be public, private, or a combination where portions are public while others are private). Therefore, user 116 uses a user device 504 to access those systems through cloud 502.

FIG. 3 also depicts another embodiment of a cloud architecture. FIG. 3 shows that it is also contemplated that some elements of system 100 are disposed in cloud 502 while others are not. By way of example, data store 106 can be disposed outside of cloud 502, and accessed through cloud 502. In another embodiment, some or all of the components of system 100 are also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. FIG. 3 further shows that some or all of the portions of system 100 can be located on device 504. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

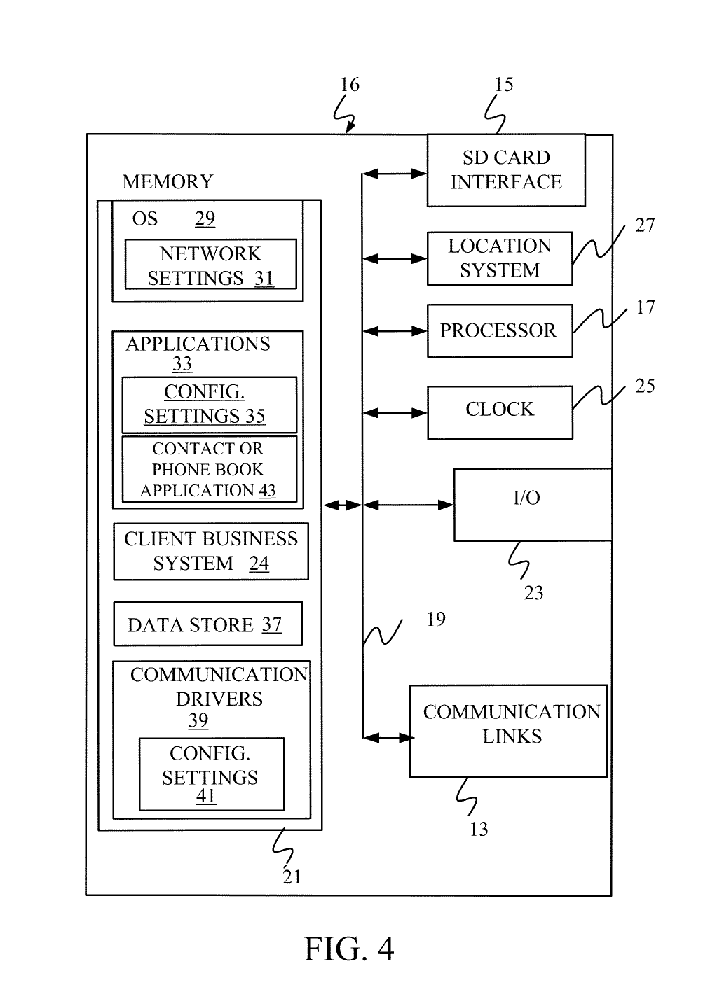

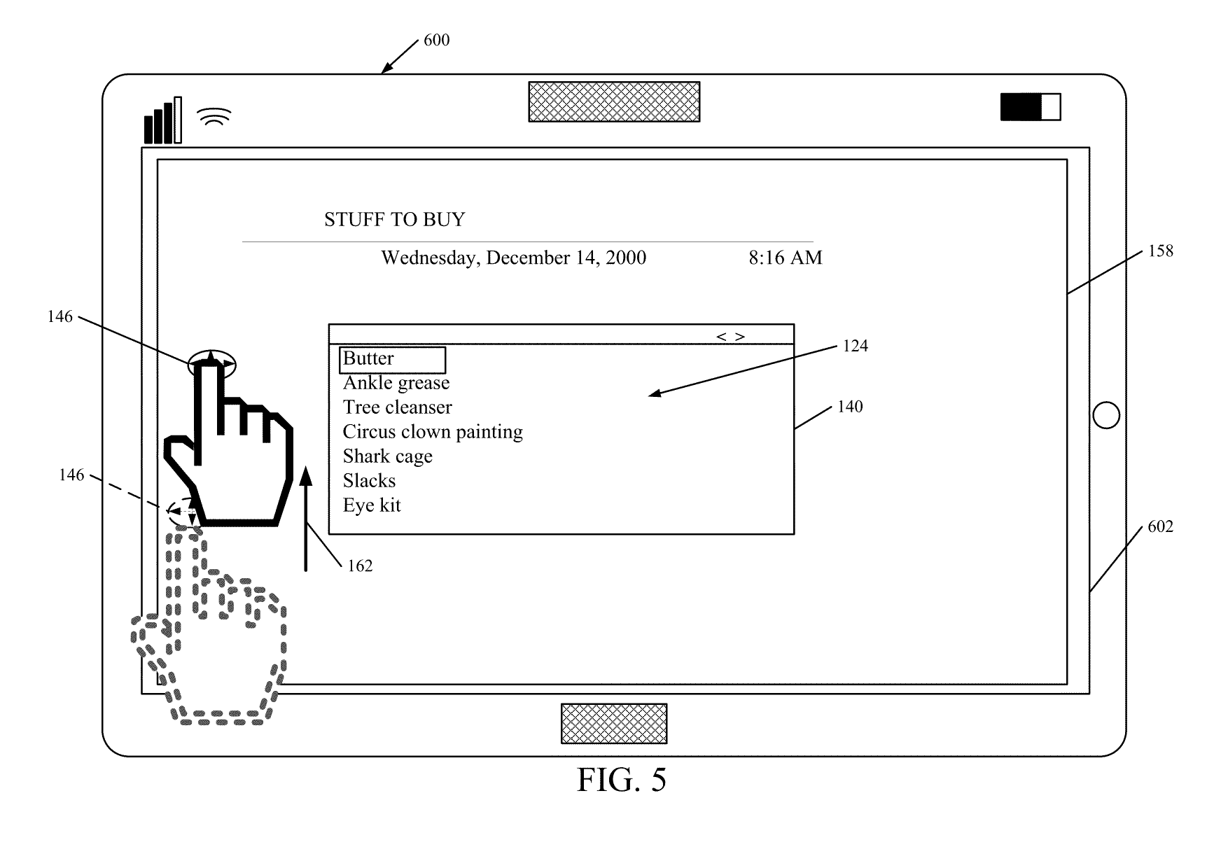

FIG. 4 is a simplified block diagram of one illustrative embodiment of a handheld or mobile computing device that can be used as a user's or client's hand held device 16, in which the present system (or parts of it) can be deployed. FIGS. 5-7 are examples of handheld or mobile devices.

FIG. 4 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processors 102 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 106, for example, can reside in memory 21. Similarly, device 16 can have a client system 24 which can run various applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can include application 104 and can be applications that have previously been stored on the device 16 or applications that are installed during use, although these can be part of operating system 29, or hosted external to device 16, as well.

FIG. 5 shows one embodiment in which device 16 is a tablet computer 600. In FIG. 5, computer 600 is shown with display screen 602. Screen 602 can be a touch screen (so touch gestures from a user's finger 106 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

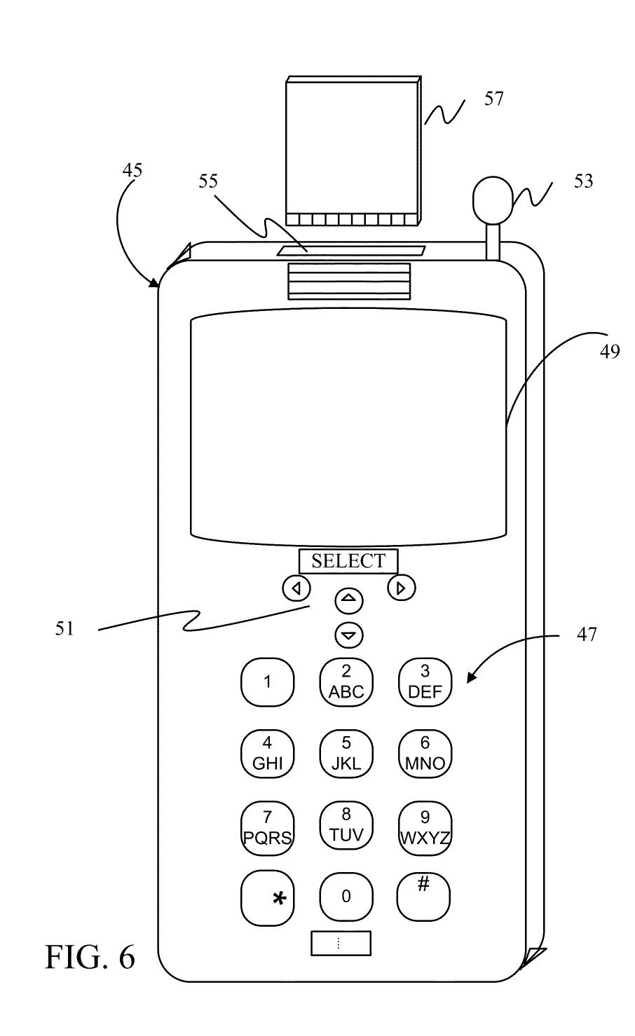

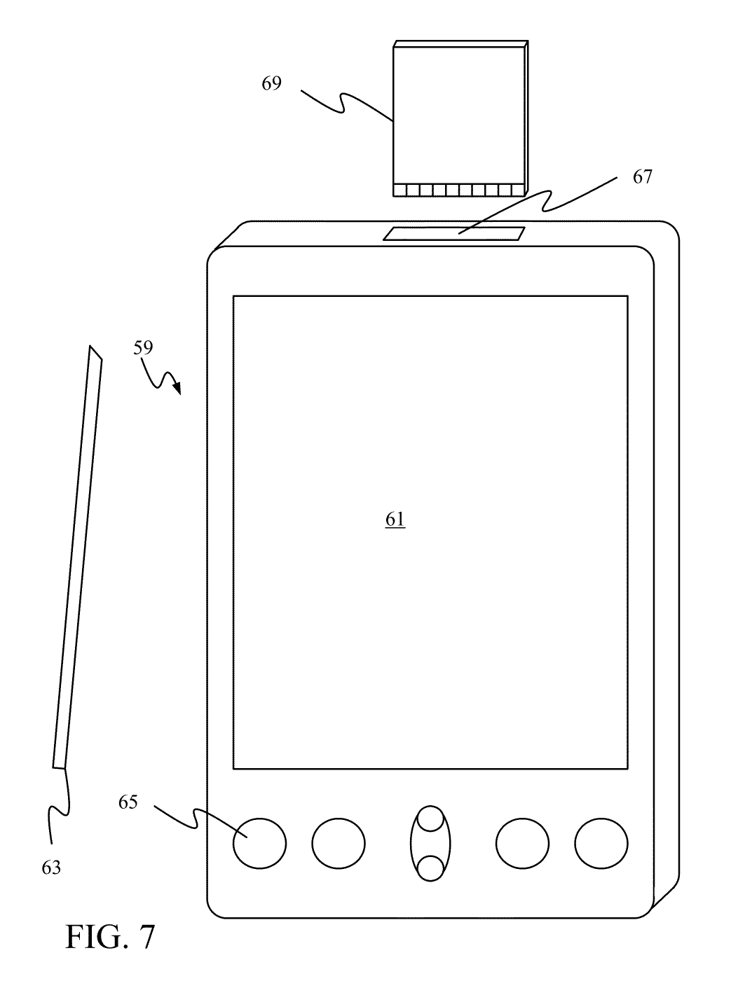

FIGS. 6 and 7 provide additional examples of devices 16 that can be used, although others can be used as well. In FIG. 6, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 7 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the device 16 are possible.

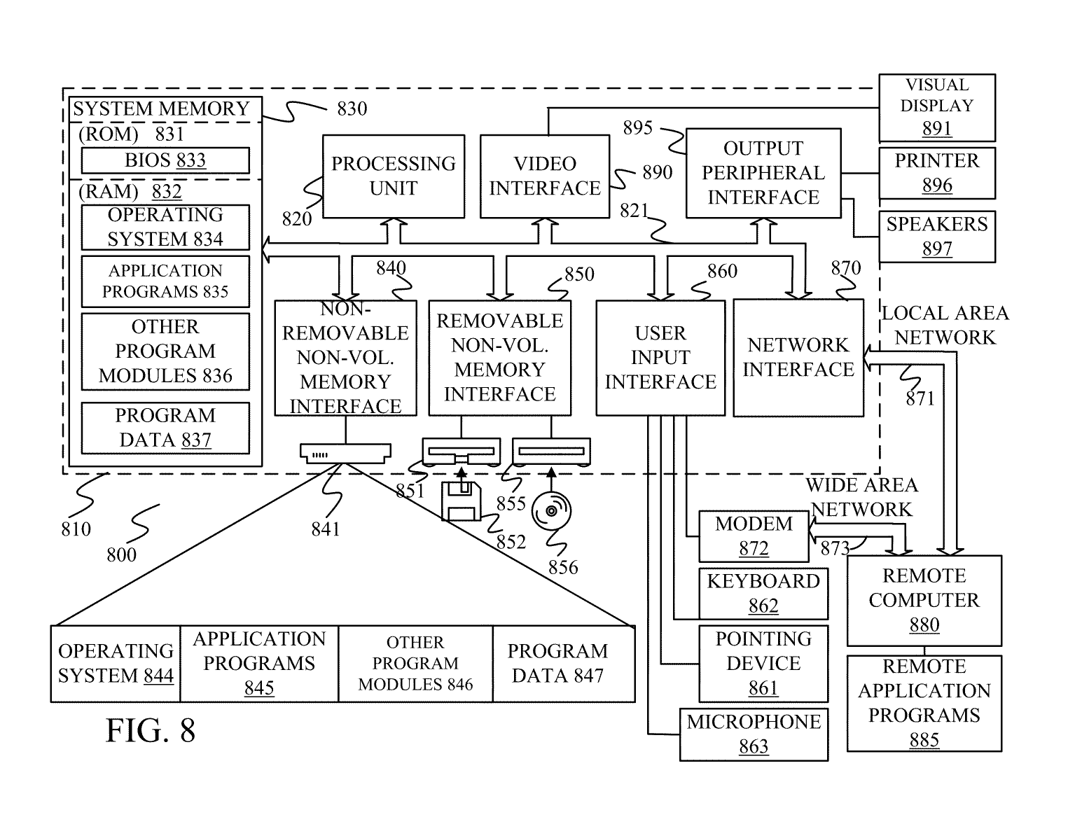

FIG. 8 is one embodiment of a computing environment in which system 100 (for example) can be deployed. With reference to FIG. 8, an exemplary system for implementing some embodiments includes a general-purpose computing device in the form of a computer 810. Components of computer 810 may include, but are not limited to, a processing unit 820 (which can comprise processor 102), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of manipulating content on a display, comprising:
generating a user interface display displaying the content on a touch sensitive display device;
receiving a first user touch gesture on the touch sensitive display device;
in response to the first user touch gesture, displaying a manipulation handle that is related to a first portion of the displayed content, but that is visually separate from the first portion of the displayed content on the user interface display; and
manipulating the first portion of displayed content based on user interaction with the manipulation handle.

2. The computer-implemented method of claim 1 wherein displaying the manipulation handle comprises displaying the manipulation handle at a different location on the user interface display than the first portion of the displayed content, and wherein manipulating the first portion of the displayed content comprises:
receiving a second user touch gesture indicative of movement of the manipulation handle; and
moving the first portion of the displayed content based on the second user touch gesture.

3. The computer-implemented method of claim 2 wherein receiving the first user touch gesture comprises:
receiving a user tap on the touch sensitive display device.

4. The computer-implemented method of claim 2 wherein receiving the first user touch gesture comprises:
receiving a user selection input selecting the first portion of the displayed content.

5. The computer-implemented method of claim 4 wherein receiving the user selection input comprises:
receiving a drag input selecting text, the selected text comprising the first portion of the displayed content.

6. The computer-implemented method of claim 4 wherein receiving the user selection input comprises:
receiving an image selection input selecting an image, the selected image comprising the first portion of the displayed content.

7. The computer-implemented method of claim 2 wherein receiving the first user input comprises:
receiving a user input to place a cursor on the user interface display.

8. The computer-implemented method of claim 5 wherein receiving the second user touch gesture comprises:
receiving a handle drag touch gesture indicative of the user dragging the manipulation handle in a given direction.

9. The computer-implemented method of claim 8 wherein the selected text comprises a selected item in a list and wherein receiving the handle drag touch gesture comprises:
receiving a reordering touch gesture that moves the selected item to a new location in the list, and wherein moving comprises automatically reordering items in the list so the selected item is at the new location.

10. The computer-implemented method of claim 8 wherein receiving the handle drag touch gesture comprises:
receiving an indent or out-dent touch gesture that indents or out-dents, respectively, the selected text relative to other text in the displayed content.

11. The computer-implemented method of claim 8 wherein the selected text comprises a portion of a larger display element and wherein receiving the handle drag touch gesture comprises:
receiving the handle drag touch gesture that drags the selected text outside a border of the larger display element; and
detaching the selected text from the larger display element so the selected text comprises a separate display element, separate from the larger display element.

12. A computing system, comprising:
a user interface component that generates a user interface display of displayed content and that receives touch gestures;
a content manipulation component that, in response to a first touch gesture, generates a display of a manipulation handle that corresponds to a first portion of the displayed content and that manipulates the first portion of the displayed content on the user interface display based on user interaction, through a second touch gesture, with the manipulation handle; and
a computer processor that is a functional part of the computing system and activated by the user interface component and the content manipulation component to facilitate generating the user interface display and manipulation of the first portion of the displayed content.

13. The computing system of claim 12 and further comprising:
a touch sensitive display device that receives the first touch gesture and the second touch gesture.

14. The computing system of claim 13 wherein the content manipulation component generates the display of the manipulation handle on the touch sensitive screen in response to the first touch gesture being a selection input that selects the first portion of the displayed content.

15. The computing system of claim 13 wherein the second touch gesture comprises a movement touch gesture that moves the manipulation handle on the user interface display and wherein the content manipulation component moves the first portion of the displayed content based on the movement of the manipulation handle.

16. The computing system of claim 15 wherein the first portion of the displayed content comprises an item in a list and wherein the content manipulation component reorders the list based on the second touch gesture.

17. The computing system of claim 13 and further comprising:
an application that uses the user interface component to generate the user interface display, wherein the content manipulation component comprises part of the application.

18. A computer readable storage medium that has computer readable instructions which, when executed by a computer, cause the computer to perform a method, comprising:
generating a user interface display displaying the content on a touch sensitive display device;
receiving a first user touch gesture on the touch sensitive display device, the first user touch gesture selecting a first portion of the displayed content;
in response to the first user touch gesture, displaying a manipulation handle that is related to the first portion of the displayed content, but that is visually separate from, and displayed at a different location on the user interface display than, the first portion of the displayed content;
receiving a second user touch gesture indicative of movement of the manipulation handle; and
moving the first portion of the displayed content on the user interface display based on the second user touch gesture.

19. The computer readable storage medium of claim 18 wherein the displayed content comprises a list of items, wherein the first portion of the displayed content comprises a selected item in the list, and wherein receiving a second touch gesture comprises:
receiving a reordering touch gesture moving the manipulation handle to move the selected item in the list to a new position in the list, and wherein moving the first portion of the displayed content comprises reordering the list, placing the selected item at the new position in the list.

20. The computer readable medium of claim 18 wherein the displayed content comprises a list of items, wherein the first portion of the displayed content comprises a selected item in the list, and wherein receiving a second touch gesture comprises:
receiving an indent or out-dent touch gesture on the manipulation handle; and
in response to the indent or out-dent touch gesture, indenting or out-denting the selected item in the list, respectively.
